(19) United States
(12) Patent Application Publication
(10) Pub. No.: US 2017/0028821 A1
(43) Pub. Date: Feb. 2, 2017

(54) ATTACHABLE/DETACHABLE SUN VISOR FACILITATING PARTIAL COUPLING

(71) Applicant: Seung Moon HA, Haksan-myeon (KR)

(72) Inventor: Seung Moon HA, Haksan-myeon (KR)

(21) Appl. No.: 15/302,989

(22) PCT Filed: Apr. 3, 2015
(86) PCT No.: PCT/KR2015/003357

§ 371 Date: Oct. 8, 2016

(30) Foreign Application Priority Data
Apr. 10, 2014 (KR) 10-2014-0043048

(51) Int. Cl. B60J 3/00; B60J 1/20

(52) U.S. Cl. CPC B60J 3/005; B60J 1/20

(57) ABSTRACT

The present invention relates to an attachable/detachable sun visor facilitating partial coupling and, more particularly, to a sun visor which can be easily attached to/detached from a vehicle window, and which enables partial coupling between the sun visor components such that components of a desired usage can be coupled and used as needed. The sun visor comprises: a body (100) coupled to a frame of a vehicle door; and an attachable/detachable ventilation extension frame (200) which is coupled to the bottom portion of the body (100) and can be expanded.

### TECHNICAL FIELD

The present invention relates to an attachable/detachable sun visor facilitating a partial coupling, and more particularly to a sun visor which can be easily attached to/detached from a vehiclewindow, and which enables partial coupling between the sun visor components such that components of a desired usage can be coupled and used as needed.

### BACKGROUND

A sun visor for a vehicle, in general, is shaped to match with the configuration of an external upper side of a door of a vehicle and is fixedly attached to the external upper side of the door in such a way to use an adhesive, for example, a double-sided tape disposed on the backside of the sun visor, thus forming a shade protecting a vehicle driver from the direct light from the sun, which consequently is able to provide the vehicle driver with convenience when driving, while preventing the input of rainwater into the vehicle.

The conventional vehicle sun visor, however, has a problem in the way that it cannot be easily separated from the door of the vehicle after the sun visor has been attached to the door of the vehicle, for which the left and right visual fields of the driver may be disturbed, and the removal of such a conventional sun visor is not easy when it needs to, and an exchange and a repair are not also easy if the sun visor has been broken.

Meanwhile, while driving a vehicle, it might need to circular the air inside of the vehicle, if necessary, or input external air into the inside of the vehicle so as to prevent any fogging on the window. In the conventional, the door window should be opened or a separate heater or air conditioner should be operated.

In order to improve the aforementioned inconvenience, the Korean utility model registration number 20-0299065 (a sun visor for a vehicle; hereinafter, it is referred to the prior art 1) describes a sun visor for a vehicle which can be easily attached to or detached from the window of the vehicle, wherein the indoor air can be effectively ventilated while efficiently preventing the input of rainwater into the inside of the vehicle, and since it can be easily attached to or detached from the door of the vehicle, so the sun visor can be detachably attached to the door of the vehicle. Moreover, the sun visor is manufactured in the same shape as the upper side of the vehicle door and is attached to the door, thus preventing any input of rainwater into the inside of the vehicle. This sun visor for a vehicle includes a plate-shaped body which has the same shape as the upper side of the vehicle door and has a concave groove which is formed at its lower portion and into which the top of the window is inserted, wherein the top of the plate-shaped body is inserted into a window concave groove of the vehicle door; and a sun visor plate which is disposed extending with a predetermined curve from one side of the outer surface of the body to an outward direction, wherein a ventilation unit is provided at a portion of the body at the inner side of the sun visor plate in order for the indoor air to be ventilated.

The Korean utility model publication number 1998-020645 (an attachable and detachable type side sun visor; hereinafter it is referred to a prior art 2) is directed to an attachable and detachable sun visor for a vehicle, which includes an integral support member formed of a fixing part formed to be inserted along a weather strip of an upper side, and a guide groove formed for the upper side of the side glass to be inserted therein; a plurality of ventilation ports formed inside of the support member; a plurality of fins which are installed above and below in the center of a plurality of the ventilation ports; a plurality of ventilation fans formed about a plurality of the fins operating as an axis; and a cover which is formed at an outer side surface from the upper portion of the support member, thus preventing rainwater from entering the inside of the vehicle.

The aforementioned prior arts 1 and 2, however, have the configuration and shape which may allow the indoor air to be ventilated, but it is hard to effectively prevent the rainwater from entering the inside of the vehicle.

Moreover, the above prior art technologies may have a limit in setting the height of the window. Since an additional component is not provided except for the sun visor, it is hard to add a separate configuration when the user wants to.

Furthermore, the above prior art technologies are not equipped with any function to prevent the attachable and detachable sun visor from randomly separating, falling and being broken during the driving of the vehicle in a state where the sun visor has been attached, wherein the aforementioned functions can be implemented in the present invention. In case of the conventional attachable sun visor, since the attachment is implemented using only an adhesive, the adhered portions may become weakened due to a temperature difference between seasons and may be separated, thus being frequently broken. In case of the exchange and attachment and detachment, a predetermined residue, which is hard to remove, may remain.

### SUMMARY OF THE INVENTION

The present invention are directed to providing an attachable/detachable sun visor facilitating a partial coupling.

The present invention are directed to providing an attachable/detachable sun visor facilitating a partial coupling, which is equipped with an air inflow member, thus efficiently allowing air to enter the inside of a vehicle.

The present invention are directed to providing an attachable/detachable sun visor facilitating a partial coupling, which allows an enhanced usability and convenience in such a way to provide an attachable/detachable sun visor which facilitates a partial coupling when a user needs to.

Various aspects of the present invention are directed to providing an attachable/detachable sun visor facilitating a partial coupling, wherein there is provided a sun visor main body shaped to be detachably attached to the top of a vehicle door and having an engaging groove which positions at a lower end of the door and into which the top of the window is inserted, in a sun visor wherein the attachable/detachable sun visor facilitating a partial coupling is detachably inserted into the top of the door frame provided at the top of the door of the vehicle window, and an attachable/detachable ventilation extension frame which includes a protrusion at the top thereof and in which a plurality of holes are perforated, thus allowing for an air circulation inside of the vehicle, wherein the attachable/detachable ventilation extension frame is inserted into the lower surface of the sun visor main body, if necessary.

Another aspects of the present invention are directed to providing an attachable/detachable sun visor facilitating a partial coupling, wherein the sun visor main body is configured in such a way that a vehicle engaging protrusion is formed at the top thereof so as to be attached or detached in a shape wherein it can be inserted into the inflow groove of the vehicle, which is provided at the top of the vehicle, and a sun visor plate is formed extending with a predetermined curve from one side portion of the outer side surface thereof to the outside, and a vehicle door fixing part is further provided at one side of each of both ends of the inner side surface of the sun visor main body and is fixed at one side of the door of the vehicle, which positions at the lower surface thereof, thus preventing the sun visor from falling from the vehicle. The attachable/detachable ventilation extension frame includes a protrusion at the top thereof for the sake of easier attachment and detachment, if necessary, at the lower surface of the sun visor main body, wherein the protrusion is engaged to an engaging groove into which the top of the window is inserted, and a groove into which the top of the window is inserted, may be formed like the lower surface of the sun visor main body.

The window fixing extension frame is included, wherein a protrusion is formed at the top thereof so as to match with the engaging groove for the sake of an easier attachment and detachment at the lower surface of the sun visor main body, and the protrusion is engaged to a groove into which the top of the window is inserted, and a groove into which the top of the window is inserted, is formed like the lower surface of the sun visor main body, and the groove includes an impact reducing part disposed in the center so as to minimize impacts that the sun visor receives when lifting up the window, thus absorbing the impacts in such a way to increase or decrease the elevating speed of the window. The sun visor can be easily attached or detached, and a partial coupling between the sun visor components is available, and components can be combined and used for the sake of a desired purpose, if necessary.

The present invention provides an attachable/detachable sun visor facilitating a partial coupling, wherein the sun visor can be selectively employed for the sake of a user's convenience, and the indoor air of a vehicle can be well circulated.

Moreover, the sun visor of the present invention can be easily attached to/detached from a vehicle door, thus enhancing usability and convenience, and an exchange and repair are easy in case of damage.

### BRIEF DESCRIPTION OF THE DRAWINGS

FIG. 1 is a perspective view of the present invention.

FIG. 2 is a rear side perspective view of the present invention.

FIG. 3 is a side view of the present invention.

FIG. 4 is a side view illustrating a coupling of the present invention.

FIG. 5 is a perspective view illustrating a main body 100 according to the present invention.

FIG. 6 is a rear side perspective view illustrating a main body 100 according to the present invention.

FIG. 7 is a perspective view illustrating an extension frame 200 according to the present invention.

FIG. 8 is a side perspective view illustrating a window fixing extension support member 300 according to another exemplary embodiment of the present invention.

FIG. 9 is an example view of another exemplary embodiment of the present invention.

FIG. 10 is a cross-sectional view illustrating a coupling between a main body 100 and a window fixing extension support member 300 according to the present invention.

FIG. 11 is an example view of another exemplary embodiment of the present invention.

FIGS. 12 and 13 are rear side perspective views of another embodiment of a main body 100 according to the present invention.

FIGS. 14 to 23 are example views illustrating a use state of the present invention.

### DETAILED DESCRIPTION OF THE EMBODIMENTS

The attachable/detachable sun visor facilitating a partial coupling according to the present invention will be described with reference to the accompanying drawings

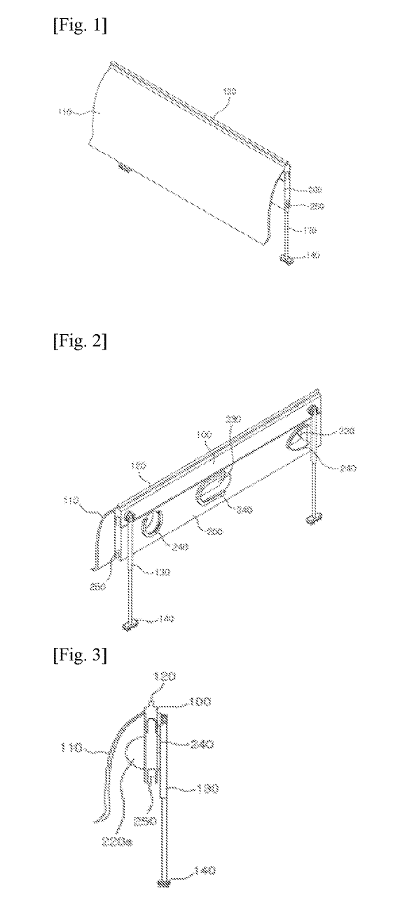

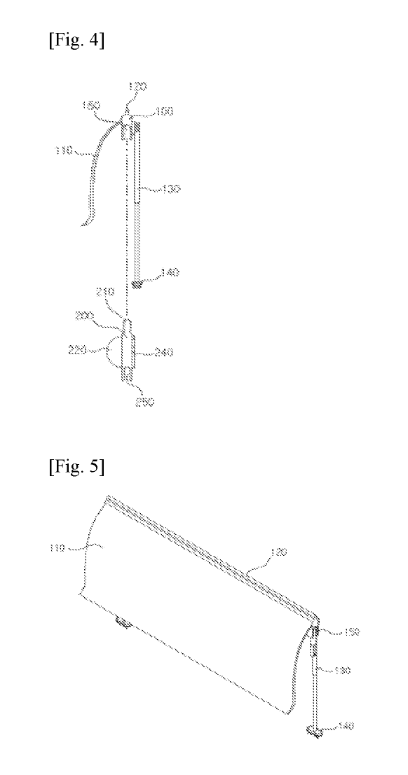

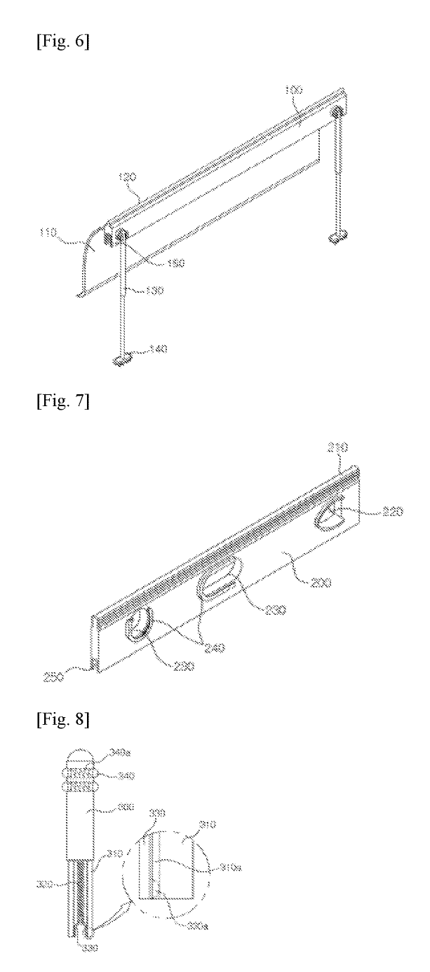

FIG. 1 is a perspective view of the present invention. FIG. 2 is a rear side perspective view of the present invention. FIG. 3 is a side view of the present invention. FIG. 4 is a side view illustrating a coupling of the present invention. FIG. 5 is a perspective view illustrating a main body 100 according to the present invention. FIG. 6 is a rear side perspective view illustrating a main body 100 according to the present invention. FIG. 7 is a perspective view illustrating an extension frame 200 according to the present invention.

The present invention will be described in details with reference to FIGS. 1 to 7, the sun visor according to the present invention may include, but is not limited to, a main body 100 engaged to the frame of a vehicle door, and an attachable/detachable ventilation extension frame 200 which is engaged to a lower portion of the main body 100 and is expandable.

A curve-shaped sun visor plate 110 is disposed at one side of the front side of the main body 100 so as to prevent rainwater, etc. from entering the inside of the vehicle, and a vehicle engaging protrusion 120 is provided at the top thereof and is formed at an inner side of the door frame of the vehicle and is engaged to a groove into which the vehicle window is inserted, and an engaging groove 150 into which one side of the top of the vehicle window is inserted and supported, is formed at the lower surface of the lower end thereof, and a vehicle door fixing part 130 is provided at one side of the rear portion thereof and is fixedly supported by the vehicle frame.

The sun visor 110 is formed extending with a constant curve formed from one side of the outer side surface to the outward direction, which means that it has the same shape as the typical sub visor, whereby the input of the rainwater into the inside of the vehicle can be reduced with the aid of the sun visor plate 110 formed extending at a predetermined angle, if a vehicle driver opens the window when it is raining.

Moreover, the vehicle door fixing part 130 disposed at the rear side of the main body 100 has a length adjusting function and a cushioning function and is equipped with a cushioning member at the inner side thereof, thus allowing for a length adjustment and an absorption of impact.

This configuration is referred to the components, for example, an elastic member and air or oil cylinder disposed at the inner side thereof, which can be easily known by a person having ordinary skill in the art, so the detailed descriptions thereof will be omitted.

The vehicle door fixing part 130 may be engaged with the aid of a hinge which is engaged through a rotary shaft to the rear side of the main body 100, and can be provided in such a way that it can be easily rotated or moved.

More specifically, the vehicle door fixing part 130 may be engaged through the rotary shaft to the main body 100, so it can rotate in the upward direction of the side surface. Since it is hinged, the upward lifting or an angle adjustment may be available.

Moreover, a fixing member 140 may be further provided at a lower portion of the vehicle door fixing part 130. If the vehicle door fixing part 130 is engaged supported to the vehicle door, the fixing member 140 is able to prevent it from slipping.

A plurality of protrusions may be provided at a lower end portion of the fixing member 140, by means of which it is possible to effectively prevent it from slipping on the surface contacting with the vehicle door.

The main door 100 may position at a lower portion of the door, and a plurality of grooves may be further formed at a lateral side of the inner circumferential surface of the engaging groove 150 into which the upper side of the window is inserted.

The aforementioned grooves are provided to maintain an engaging strength when the extension frame 200 engaged to the main body 100 and the window fixing extension support member 300 are engaged with each other.

The extension frame 200 extending engaged to a lower end portion of the main body 100 may have a protrusion 210 at its top for the sake of an easier and detachable engagement to the lower surface of the main body 100, if necessary, and the protrusion 210 may be engaged to an engaging groove 150 formed at the lower surface of the main body 100. A groove 250 may be formed at the lower surface of the extension frame 200 in order for a part of the top of the vehicle window to be inserted supported into the groove 250.

Moreover, an intake port 220 and a ventilation window 230 may be provided at the extension frame 200 for the sake of an easier air circulation inside is of the vehicle.

The intake port 220 may position at a front portion of the extension frame 200 and may include an inflow blade 220a to input external air into the inside of the vehicle. One side of the inflow blade 220a is formed in a semispherical shape one side of which is open, thus allowing the external air to gather when the vehicle is being driven and guide into the intake port 220.

The ventilation window 230 formed spaced apart from the intake port 220 is able to discharge the air inside of the vehicle to the outside.

The internal air inside of the vehicle may be pushed to the outside by means of the external air which is forcibly inputted from the intake port 220 disposed at the front portion, and the internal air inside of the vehicle can also be naturally discharged to the outside, when the vehicle is being driven forward, through the ventilation window 230 with the aid of the air current formed behind the intake port 220 which is formed protruding outward.

This air circulation is referred to the principle of Bernoulli. Since a person having ordinary skill in the art well knows about this principle, the detailed description thereof will be omitted.

An opening and closing window (not illustrated), which can be opened or closed, may be further provided near an open port and at the intake port 220 and an inner side surface of the ventilation window 230. A rail 240 may be provided along the outer circumferential surface of the open port at the inner side surface of the thereof in order to install the opening and closing window.

As a part of an opening window may be installed inserted in the rail 240 and may be opened or closed, by which the opening window can move in the horizontal direction or the vertical direction and then can be opened or closed.

It has been intended to control for external air inflowed vehicle interior.

The main body 100 and the extension frame 200 coupled to the main body 100 may be implemented individually or may be configured combined with each other.

A part of the top of the vehicle window may be inserted in the engaging groove 150 formed at the lower surface of the main body 100. Alternatively, the protrusion 210 formed at the top of the extension frame 200 may be inserted into the engaging groove 150 of the main body and may be engaged thereto, and then a part of the top of the vehicle window 230 may be inserted supported in the groove 230 formed at the lower surface thereof in case of the actual application.

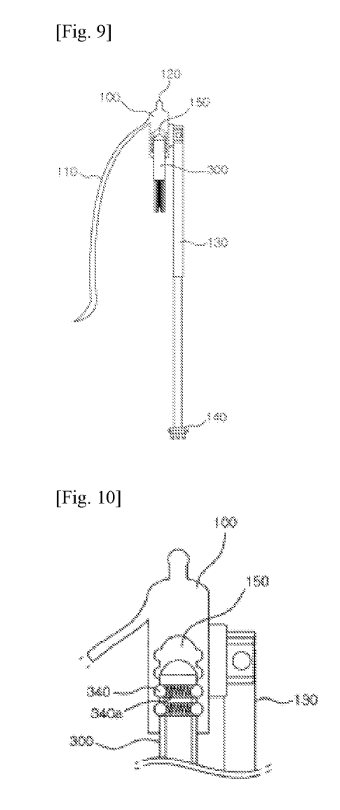

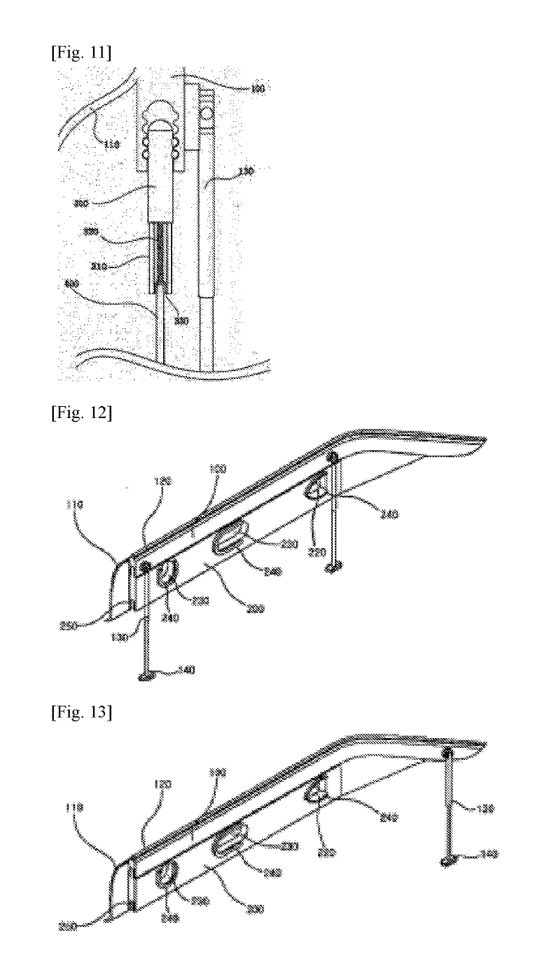

FIG. 8 is a side perspective view illustrating a window fixing extension support member 300 according to another exemplary embodiment of the present invention. FIG. 9 is an example view of another exemplary embodiment of the present invention. FIG. 10 is a cross-sectional view illustrating a coupling between a main body 100 and a window fixing extension support member 300 according to the present invention. FIG. 11 is an example view of another exemplary embodiment of the present invention.

The aforementioned configuration will be described with reference to FIG. 8 to 11. The main body 100 or the extension frame 200 may be installed at the vehicle door. If a user opens the vehicle window in this state, since the support strength may be weakened, the main body 100 or the extension frame 200 may separate from the vehicle door.

There may be further provided a window fixing extension support member 300 to prevent the main body 100 or the extension frame 200 from escaping from the vehicle door and to open the vehicle window.

The window fixing extension support member 300 may be equipped with a pair of support members 310 which are disposed at one side of the lower end portion thereof and are spaced apart from each other. An elastic member 320 is provided at the inner sides of the support members 310. An engaging horseshoe member 330 may be engaged to an end portion of the elastic member 320, and a ball clamp 340 may be provided at the top thereof.

A guide groove 310a may be formed in the vertical direction at the inner circumferential surface of the support member 310. A guide protrusion 330a formed at one side of the engaging horseshoe member 330 can be inserted into the guide groove 310a. In this state, when the engaging horseshoe member 330 moves along the support member 310, the engaging horseshow member 330 can move along a predetermined trajectory without separating from the support member 310 to the outside thereof.

A part of the top of the vehicle window 400 is inserted and supported by the configured engaging horseshoe member 330.

Moreover, the ball clamp 340 disposed at the top thereof is supported by the elastic member 340a disposed at the inner side, thus having an elastic force. If the ball clamp 340 receives an external pressure, the ball clamp 340 may move inward, and if the pressure is removed, it may move outward by the elastic force.

The engaging strength can be enhanced by the ball clamp 340 since it is engaged to the engaging groove 150 or the 230 formed at the main body 100 or the lower surface of the extension frame 200.

The window fixing extension support member 300 is engaged to the main body 100 or the extension frame 200, and then a part of the top of the vehicle window is inserted in the engaging horseshoe member 330 and is supported in place. If the user wants to open the vehicle window, the engaging horseshoe member 330 may move downward along the vehicle window by means of the elastic force of the elastic member 320 while maintaining a support strength.

FIGS. 12 and 13 are rear side perspective views of another embodiment of a main body 100 according to the present invention.

The aforementioned configuration will be described with reference to FIG. 12 The main body 100 according to the present invention may be implemented in various shapes. According to an embodiment of the present invention, an expansion blade may be further provided based on the shape of the front door of the vehicle.

More specifically, the downwardly curved expansion blade may be provided at a front portion of the main body 100 based on the shape of the frame of the front door of the vehicle. Since this configuration is well known in the related technology field, the detailed description thereof will be omitted.

The aforementioned configuration will be described with reference to FIG. 13. The main body 100 according to the present invention may be implemented in various shapes. According to an exemplary embodiment of the present invention, an expansion blade may be further provided based on the shape of the front door of the vehicle, and a vehicle door fixing part 130 may be provided at one side of the expansion blade.

More specifically, one vehicle door fixing part 130 may be provided at one side of the expansion blade which is curved in the downward direction of the front portion of the main body 100 based on the formation of the frame of the front door of the vehicle. The vehicle door fixing part 130 may be supported by a side mirror of the vehicle and then may be engaged thereto. Since this configuration is being widely used, the detailed description thereof will be omitted,

It is obvious that the aforementioned description is referred to just an embodiment of the present invention, and it can be actually applied in various forms.

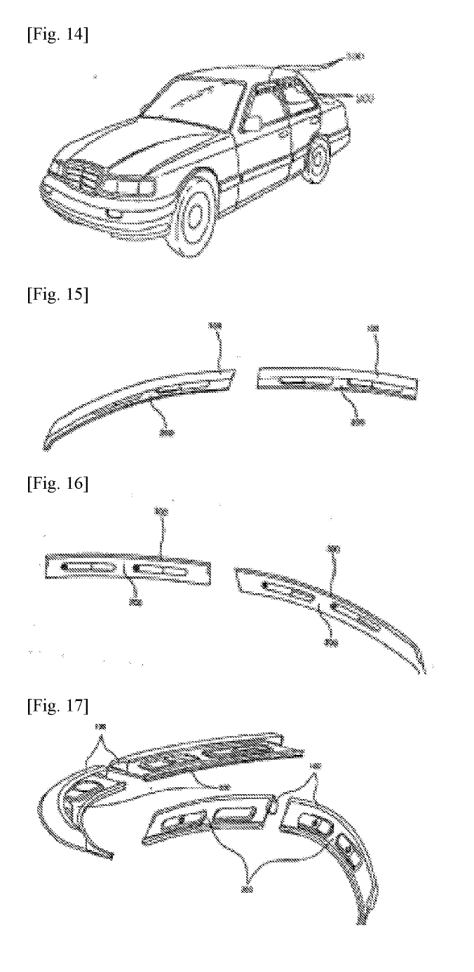

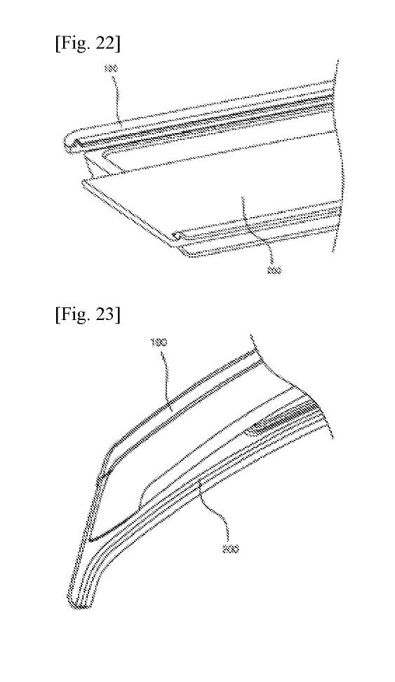

FIGS. 14 to 23 are example views illustrating a use state of the present invention.

Referring to FIGS. 14 to 17, the use state of the present invention will be described. The main body 100 and the extension frame 200 may be implemented individually or may be configured combined with each other. They may be selectively applied to the front door as well as the rear door of the vehicle.

Here, the main body 100 may be implemented in an individual form or the extension frame 200 may be implemented an individual form. Alternatively, the extension frame 200 may be combined with the main body 100 in case of an actual application.

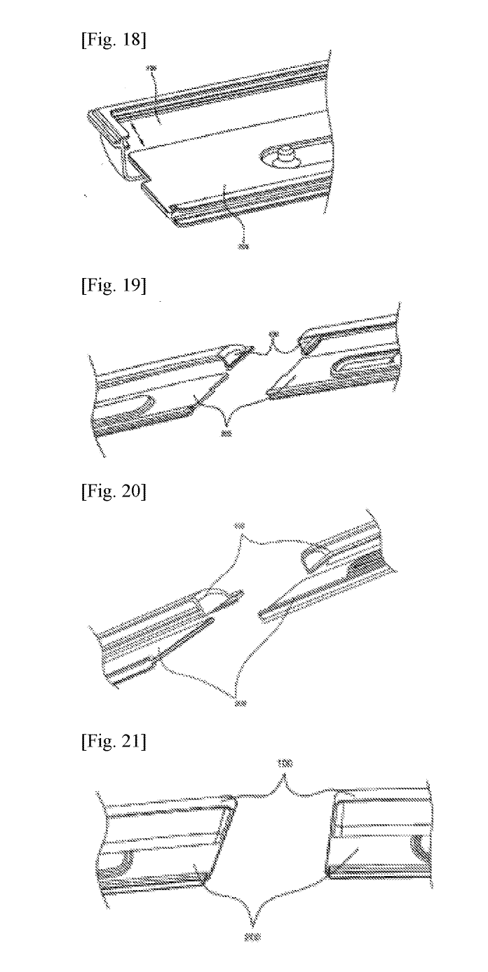

Referring to FIGS. 18 and 19, the main body 100 according to the present invention may include an engaging groove which is formed at a lower end of the door and into which the top of the extension frame 200 is inserted, and the engaging groove may be configured in such a way that the top of the extension frame 200 can be engaged thereto in a sliding way.

Moreover, there may be provided a groove which may allow a part of the top of the vehicle window to be inserted into the lower surface of the extension frame 200 and to be supported in place.

Referring to FIGS. 20 to 22, the main body 100 of the present invention may include an engaging part which may position at a lower end of the door and into which the top of the extension frame 200 is inserted. The engaging part may be engaged in such a way that the top of the extension frame 200 can be engaged in a binding way.

Moreover, a groove may be formed at the lower surface of the extension frame 200, wherein a part of the top of the vehicle window is inserted into the groove and is supported in place.

Referring to FIG. 23, the main body 100 and the extension frame 200 of the present invention are formed integral with each other, and a groove may be formed at the lower surface of the extension frame 200, wherein a part of the top of the vehicle window is inserted into the groove and is supported in place.

It is obvious that the aforementioned configuration can be implemented in various forms.

The present invention may be implemented by means of the above described configurations and methods.

What is claimed is:

1. An attachable/detachable sun visor facilitating a partial coupling, comprising:
a main body (100) which is engaged to a frame of a vehicle door; and
an attachable/detachable ventilation extension frame (200) which is engaged to a lower end portion of the main body (100) and is expandable.

2. An attachable/detachable sun visor facilitating a partial coupling, comprising:
a main body (100) wherein a curve-shaped sun visor plate (110) which is provided at one side of a front side thereof so as to prevent the input of rainwater into the inside of a vehicle in an expandable sun visor which is inserted into a door frame disposed at the top of the vehicle door and is easily attachable or detachable, a vehicle engaging protrusion (120) is provided at the top thereof, wherein the vehicle engaging protrusion (120) can be engaged to a groove into which the vehicle window at the inner side of the door frame of the vehicle can be inserted, an engaging groove (150) is formed at the lower surface of the lower end portion thereof, wherein a part of the top of the vehicle window or a protrusion (210) of the extension frame (200) is inserted into the engaging groove (150) and is engaged thereto and supported in place, and a vehicle door fixing part (130) is provided at one side of the rear surface thereof and is supported by the vehicle frame and is fixed in place; and
an extension frame (200) wherein a protrusion (210) is provided, which is engaged corresponding to the engaging groove (150) of the main body (100), and a groove (250) is formed at the lower surface thereof, wherein a part of the top of the vehicle window is inserted, supported in place and engaged thereto, and an intake port (220) and a ventilation window (230) are provided to facilitate an air circulation inside of the vehicle, wherein the main body (100) and the extension frame (200) can be coupled or can be individually attached to the vehicle door when in use.

3. The sun visor of claim 2, wherein the vehicle door fixing part (130) is coupled with the aid of a hinge which is engaged about a rotary shaft to one side of the rear surface of the main body (100), so it can easily rotate and move, and a cushioning member, for example, an elastic member and an air or oil cylinder is provided at an inner side thereof for the sake of a length adjustment and a cushioning function, thus absorbing a length adjustment and impact.

4. The sun visor of claim 3, wherein a plurality of protrusions are provided in the downward direction at a lower end portion of the vehicle door fixing part (130), and a fixing member (140) is further provided so as to prevent any slipping when the vehicle door fixing part (130) is supported and engaged to the vehicle door.

5. The sun visor of claim 2, wherein an inflow blade (220a) is provided at an outer circumferential surface of the outer side of the intake port (220) which position at a front portion of the side surface of the extension frame (200), by which an external air is collected and forcibly inputted into the intake port (220) when a vehicle is being driven, wherein it is formed in a semispherical shape one side of which is open.

6. The sun visor of claim 2, wherein a rail 240 allowing for the installation of an opening and closing window is further provided near the intake port (220) and an open portion of the inner side surface of the ventilation window (230), wherein the opening and closing window can be opened or closed.

7. The sun visor of any of claims 2 to 6, further comprising a window fixing extension support member (300) which is attachable or detachable and is able to prevent the main body (100) or the extension frame (200) from separating from the vehicle door if a support strength is weakened when the vehicle window is opened after the main body (100) or the extension frame (200) has been installed at the vehicle door.

8. The sun visor of claim 7, wherein the window fixing extension support member (300) includes a pair of support members (310) which are disposed at one side of the lower end portion thereof and are spaced apart from each other, and an elastic member (320) disposed at an inner side of the support member (310), and an engaging horseshoe member (330) is engaged to an end portion of the elastic member (320) and is inserted into one side of the top of the vehicle window and is supported in place, and a ball clamp (340) supported by the elastic member (340a) having an elastic force is provided at the top thereof.

9. The sun visor of claim 8, wherein a guide groove (310a) is formed in the vertical direction at an inner circumferential surface of a pair of the support members (310), and a guide protrusion (330a) corresponding to the guide groove (310a) is formed at one side of the engaging horseshoe member (330), by which when the engaging horseshoe member (330) moves along the support member (310), it can move maintaining a predetermined trajectory along the guide groove (310a), thus preventing the engaging horseshoe member (330) from separating to the outside of the support member (310).
